(19) United States
(12) Patent Application Publication
(10) Pub. No.: US 2025/0296626 A1
(43) Pub. Date: Sep. 25, 2025

(54) SELF-DRIVING VEHICLE FOR TRANSPORTING A RECEIVING CONTAINER FOR A SLIVER, AND CAN DEVICE

(71) Applicant: TRÜTZSCHLER GROUP SE, Mönchengladbach (DE)

(72) Inventor: Johannes BOSSMANN, Sonsbeck (DE)

(73) Assignee: TRÜTZSCHLER GROUP SE, Mönchengladbach (DE)

(21) Appl. No.: 18/863,944

(22) PCT Filed: May 5, 2023
(86) PCT No.: PCT/EP2023/062017

§ 371 Date: Nov. 7, 2024

(30) Foreign Application Priority Data
May 10, 2022 (DE) 10 2022 111 675.1
May 24, 2022 (EP) 22175157.1

(51) Int. Cl. D01H 9/18

(52) U.S. Cl. CPC B62D 15/00

(57) ABSTRACT

A self-driving vehicle for transporting a receiving container for a fibre sliver over an underlying surface between sliver-delivering and sliver-fed textile machines. The vehicle has an undercarriage with a plurality of wheels, a vehicle body supported by the undercarriage, a transport surface for the receiving container, fastening elements for fastening the receiving container to the vehicle body, an on-board electrical system having an electrical energy storage means, an electrical drive unit and a control unit. The wheels include two fixed wheels aligned in a longitudinal direction of the vehicle and having rotational axes fixed with respect to the vehicle body and at least one spring-mounted support wheel supported on the vehicle body via a spring arrangement and configured to be freely pivotable about a pivot axis. The invention also relates to a can device having a receiving container for a fibre sliver and the self-driving vehicle.

### CROSS-REFERENCE TO RELATED APPLICATIONS

This application is a U.S. National Stage of International application PCT//EP2023/062017 filed May 5, 2023, which claims priority from German Application DE 10 2022 111 675.1 filed May 10, 2022, and European Application EP 22175157.1, filed May 24, 2022

### BACKGROUND OF THE INVENTION

The present invention relates to a self-driving vehicle for transporting a receiving container for a fibre sliver over an underlying surface between sliver-delivering and sliver-fed textile machines, the vehicle having an undercarriage with a plurality of wheels, a vehicle body which is supported by the undercarriage and has a transport surface for the receiving container, fastening elements for fastening the receiving container to the vehicle body, and an on-board electrical system having an electrical energy storage means, an electrical drive unit and a control unit, which electrical system is arranged on the vehicle body, wherein the wheels comprise two fixed wheels which are aligned in a longitudinal direction of the vehicle and have rotational axes that are fixed with respect to the vehicle body. The present invention further relates to a can device having a receiving container for a fibre sliver and the self-driving vehicle.

In spinning rooms there are customarily used several hundreds of sliver cans, also known as spinning cans or simply cans, which have hitherto predominantly still been moved between the textile machines by hand. This involves a large amount of manpower. In order to reduce the manpower involved, attempts have already been made for decades to automate the transport of the cans.

CN 212685777 U discloses a self-driving vehicle, what is known as an automatic guided vehicle, abbreviated to AGV, which automatically carries and transports sliver cans. The vehicle has an adjustable tightening device which is able to adapt to different sizes of can. The can is placed on the top of the vehicle by a transfer device and fixed by the tightening device which is applied to the exterior of the can. Once the vehicle has transported the can and unloaded it again, it is ready for transporting the next can.

### SUMMARY OF THE INVENTION

An object of the present invention is to provide, among other things, a self-driving vehicle which can be better integrated into the ongoing operation of a spinning room and which is cost-effective to produce as well as easy to maintain. A further object of the present invention is to provide a can device which can be better integrated into the ongoing operation of a spinning room and which is cost-effective to produce as well as easy to maintain.

That and other objects are achieved in a self-driving vehicle of the kind mentioned at the beginning by the wheels' comprising at least one spring-mounted support wheel which is supported on the vehicle body via a spring arrangement and is configured so as to be freely pivotable about a pivot axis.

In the context of the present description, for the sake of simplicity, instead of referring to “at least one spring-mounted support wheel” reference will often be made only to “the spring-mounted support wheel”. It will be understood that this does not exclude the wheels being able to comprise more than one spring-mounted support wheel. If the exact number of spring-mounted support wheels is important, for example exactly one, two or more than two, this will be indicated accordingly.

It is advantageous that the self-driving vehicle, which is configured for transporting the one receiving container, can be integrated into the ongoing operation of the spinning room in the same way as a conventional sliver can. Therefore, no modifications or other adjustments to the machinery in the spinning room are necessary, with the result that the self-driving vehicle can be better integrated into the ongoing operation of a spinning room. The spring arrangement, or simply “suspension”, is part of the undercarriage. It carries the weight of the structure and is intended to ensure that the structure, especially the receiving container being carried, which may be full of fibre sliver, remains still and that stimuli from the underlying surface are not transmitted directly to the structure. By means of the spring-mounted support wheel, the vehicle is able to travel over ascending or descending slopes, such as, for example, ramps on can changers of textile machines, even in the laden state. By virtue of the spring-mounted support wheel, the wheels remain in contact with the floor even in the case of a sloping underlying surface. Furthermore, the free pivotability of the spring-mounted support wheel also allows pivoting movements through more than 360 degrees, so that the support wheel is able freely to follow any direction of travel of the vehicle. As a result, the spring-mounted support wheel provides a simple way of increasing the stability of the vehicle in a cost-effective and easy-to-maintain way.

The spring arrangement enables all the wheels to be in contact with the underlying surface when the vehicle is rolling over the floor. For example, the spring arrangement can comprise a coil spring and, if necessary, wheel-guiding means, such as a wheel-guiding damper. Alternatively or in addition, the spring arrangement can have at least one torsion spring, especially a leg spring. The spring may be a three-dimensionally wound flexible spring made from spring wire, which can have a cylindrical spring body. The spring body can be adjoined by legs, it being possible for a wheel axle of the support wheel to be supported on a first leg and the vehicle body to be supported on a second leg. The spring arrangement can comprise a double-leg spring which can consist of two torsion springs, or leg springs, joined to one another.

The fixed wheels are not steerable and are preferably fixedly aligned in the longitudinal direction of the vehicle. In particular, the fixed wheels are not spring-mounted on the vehicle body. Preferably, in the context of the present description “not spring-mounted” is intended to mean that no movement in the longitudinal direction of the vehicle is possible. The rotational axes of the two fixed wheels can lie on a notional straight line. The notional straight line divides the vehicle body in the longitudinal direction of the vehicle into a front portion and a rear portion. The two portions can be of at least approximately equal size. Furthermore, it can be provided that a yaw axis of the vehicle perpendicularly intersects the notional straight line. The yaw axis can also be referred to as the vertical axis of the vehicle and is the axis about which the vehicle turns on the underlying surface during maneuvering. Preferably, the yaw axis is located centrally between the two fixed wheels. The vehicle is therefore able to turn on the spot. In particular, the yaw axis passes through a centre point of the vehicle body.

Furthermore, the drive unit can be in driving connection with at least one of the wheels. The spring-mounted support wheel ensures that, even in the case of uneven floors, inclined surfaces, such as, for example, of ramps and the like, the wheels always maintain contact with the floor, so that the at least one driven wheel is able to transmit the drive power generated by the drive unit to the floor. Preferably, the drive unit is in driving connection with the two fixed wheels. In particular, the drive unit can have an electric motor, especially a wheel hub motor, for each fixed wheel. The vehicle can be steered in a simple way by altering the rotational speed ratio between the two electric motors and/or their directions of rotation (in the same direction, in opposite directions). The spring-mounted support wheel follows the route as a result of its free pivotability. Preferably, the two electric motors are each connected to a servo converter which supplies the respective electric motor with the power required for the movement. In the case of actuation in opposite directions, the vehicle is able to turn on the spot. In particular, instead of individual servo converters it is also possible to provide a double converter in the case of two driven wheels or a multiple converter in the case of, for example, three driven wheels. Instead of the servo converter it is also possible to use a frequency converter or other means for achieving the specified rotational speed, provided a rotational speed is specified and actuated or can be implemented for each electric motor individually. It is further of advantage that the vehicle does not require an additional transmission, with the result that the vehicle is more cost-effective and easier to maintain. Instead of the advantageous configuration having two electric motors, the drive unit can also have one electric motor with a transmission which drives the two fixed wheels.

In a development, the pivot axis of the spring-mounted support wheel can be aligned parallel to the yaw axis. As a result, the vehicle is able to turn on the spot, that is to say about its yaw axis. The vehicle is therefore able to turn in a space-saving way, preferably without swinging out, and can, for example, turn on the spot below a coiler plate of a sliver-delivering textile machine.

In particular, the spring-mounted support wheel is supported against the rear portion of the vehicle body. As a result, the vehicle is better able to travel over ramps that bridge differences in height. The rear portion is situated at the rear during forward travel of the vehicle, that is to say it trails behind the front portion of the vehicle body.

Furthermore, it can be provided that the wheels comprise at least one further support wheel which is configured so as to be freely pivotable about a further pivot axis. The at least one further support wheel can be spring-mounted or non-spring-mounted on the vehicle body. The at least one further support wheel can be supported against the front portion without spring-mounting. As a result of the spring-mounted support wheel's being supported against the rear portion and the non-spring-mounted support wheel's being supported against the front portion, the vehicle, in addition to being able to travel over flat floor surfaces, is also able to travel especially well, and without tilting, over the sloping floor surfaces of ramps or the like. In addition, the vehicle is prevented from becoming unstable when travelling over sloping surfaces, when passing over uneven underlying surfaces as well as during acceleration and deceleration. Alternatively, the at least one further support wheel can also be supported against the front portion via a further spring arrangement, that is to say it can be a spring-mounted support wheel.

In particular, the pivot axes of the spring-mounted support wheel and the at least one further support wheel, which are referred to jointly as the support wheels hereinbelow, are aligned parallel to one another and, more preferably, parallel to the yaw axis. It has been found that on account of the spatial conditions and the multiplicity of cans in the spinning room it can be advantageous if the vehicle is able to turn on the spot. This can be implemented in a simple way by the proposed central arrangement of the fixed wheels in relation to the longitudinal direction in combination with two of the support wheels. Preferably, the undercarriage is of four-wheeled or six-wheeled configuration, because in order further to increase stability the wheels can also comprise four of the support wheels, so that the vehicle can comprise a total of six of the wheels. In particular, in addition to comprising the two fixed wheels, the wheels can comprise two of the spring-mounted support wheels and two of the non-spring-mounted support wheels. The spring-mounted support wheels can be supported against the rear portion of the vehicle body. The non-spring-mounted support wheels can be supported against the front portion of the vehicle body. In general, three-point support with three of the wheels, especially the two fixed wheels and the one spring-mounted support wheel, also has advantages in respect of the stability of the vehicle on the underlying surface.

In accordance with one configuration, the support wheel and the at least one further support wheel can be spaced apart from one another in the transverse direction of the vehicle. In particular, the support wheels can be arranged between the two fixed wheels in the transverse direction of the vehicle, so that the support wheels roll over the underlying surface outside the tracks of the fixed wheels. Furthermore, a wheel-free function portion can be formed between the support wheels, which function portion extends in the longitudinal direction of the vehicle. Components of the on-board electrical system can be arranged on the function portion. In particular, the function portion extends over the entire longitudinal extent of the vehicle body. In preferred manner, the on-board electrical system can have a reading unit which is configured for detecting guide elements arranged on the underlying surface. By means of the guide elements it is possible to specify fixed routes between the textile machines. The reading unit can be arranged on the wheel-free function portion of the vehicle body. As a result, the wheels, on rolling over the underlying surface, are largely prevented from rolling over the guide elements, with the result that the guide elements are protected from excessive wear.

In a further configuration, the vehicle can be dimensioned in such a way that in an installed state, in which the receiving container is in contact with the transport surface and is fastened to the vehicle body, the receiving container entirely covers the undercarriage, the electrical drive unit and the electrical energy storage means. Furthermore, the vehicle can be dimensioned in such a way that in the installed state the receiving container entirely covers the vehicle body. In other words, the vehicle is dimensioned relative to the receiving container, that is to say provided with an extent perpendicular to the vertical axis of the vehicle, in such a way that the space requirement or functional surface area of the vehicle during operation is at least substantially limited to the size of the footprint or cross-sectional area of the receiving container. The footprint of the receiving container, detached from the vehicle, is understood to be that floor area of the underlying surface which is required for the receiving container in the mounted state, irrespective of whether or not the container is touching the underlying surface. The functional surface area of the vehicle is that floor area of the underlying surface which is covered by the vehicle during operation. The overall size of the vehicle is dimensioned in such a way that the vehicle is at least substantially accommodated below the receiving container when the latter is in contact with the transport surface and is fastened to, or installed on, the vehicle by means of the fastening elements (=installed state). “At least substantially” is intended to include the vehicle's being arranged virtually entirely underneath the receiving container in the installed state, with only individual components, especially from the on-board electrical system, being able to project laterally beyond the receiving container if there is a technical necessity therefor. In principle, however, it is also possible for the whole vehicle to be entirely covered by the receiving container. The undercarriage, the electrical drive unit and the transport surface are accordingly located below the receiving container in the installed state and are therefore concealed by the receiving container in a plan view from above. The vehicle is accordingly configured for transporting only a single receiving container. It is advantageous that in the installed state the vehicle is largely protected by the receiving container. The small space requirement provides the further advantage that, in the installed state, the vehicle requires the same amount of space and preferably also has the same overall height as a manually movable standard can. This has the advantage that by the use of the vehicle it is possible to provide self-driving sliver cans which can be used without structural adjustments to the textile machines already present in the spinning room.

In particular, the transport surface can define a support plane. Preferably, the vehicle has no components that project beyond the support plane outside the transport surface. It is advantageous that accordingly no components coming from below, that is to say coming from the undercarriage, project laterally past the transport surface and upwards beyond the support plane. In particular, “laterally of the transport surface” is to be understood as radially outside the transport surface in relation to the vertical axis of the vehicle. In that way the vehicle has no troublesome components, such as edges, mountings, bars, loading and unloading devices or the like, laterally of the transport surface, with the result that the receiving container to be transported can be simply set down on the vehicle to establish the installed state. The transport surface preferably lies in the support plane, which can be aligned parallel to the underlying surface. Inside the transport surface, that is to say that surface which is in contact with the receiving container in the installed state, there can be provided fastening elements which are in principle also able to project beyond the support plane, for example bolts, screws or the like.

As a result, in the installed state, the vehicle, like a conventional sliver can, that is to say a manually moved sliver can, is able to access working areas of the textile machines, such as a filling station on a can changer or the like, and can accordingly also be used for performing movements in the working areas. For example, the vehicle can be rotated together with a can rotary plate of the textile machine or the vehicle, by virtue of its drivable undercarriage, is itself able to rotate below a coiler plate of the textile machine.

A further way of achieving the above-mentioned object lies in a can device having a receiving container for a fibre sliver and the above-described self-driving vehicle for transporting or carrying the receiving container over the underlying surface between sliver-delivering and sliver-fed textile machines. The can device can also be referred to as a “self-driving can”. The receiving container is in contact with the transport surface of the self-driving vehicle and is fastened to the vehicle body, the receiving container entirely covering the undercarriage, the electrical drive unit and the energy storage means. The can device according to the invention brings about the same advantages as those described in connection with the vehicle according to the invention, so that here brief reference is made to the above description, it being understood that all mentioned configurations of the vehicle are transferrable to the can device and vice versa.

Furthermore, the receiving container can also entirely cover the vehicle body. This simplifies the handling of the can device in the daily operation of the spinning room, because the can device occupies only the same amount of space as a conventional sliver can.

The can device is of modular construction and comprises the self-driving vehicle and the receiving container as modules. The modular construction enables the production costs to be reduced, because the vehicle and the receiving container can be produced separately from one another and even by different manufacturers. The vehicle is “married” to the one receiving container and remains permanently connected thereto (=installed state). Preferably, separation is necessary only in the event of the vehicle's being defective or for maintenance purposes. The purpose of such a permanent connection is that the loading and unloading of the receiving container from the vehicle, which is regarded as disadvantageous, is not required. The fastening of the receiving container to the vehicle is an installation step that is preferably carried out manually, but which can in principle also be carried out by an industrial robot.

The footprint of the receiving container can be defined by the side wall extending around the container axis in the circumferential direction. The footprint can correspond to the cross-sectional area of the receiving container. Because the space required by the vehicle is at least substantially limited to the size of the footprint of the receiving container, the can device can externally largely correspond to a conventional spinning room can having rollers attached to its underside (also referred to as a “standard can”). In preferred manner, the can device has the same dimensions as the standard can that is to be replaced. Accordingly, the can device, like a standard can, is able to enter the working areas of the textile machines, such as filling stations on a can changer or the like, and therefore can also be used for performing movements in the working areas. The change from the standard can to the self-driving can device therefore does not necessitate any adjustments to the textile machines.

The receiving container is in contact with the transport surface of the vehicle, which transport surface is at most the same size as, or is preferably smaller than, the footprint of the receiving container. Preferably, the vehicle carries the receiving container which is correspondingly spaced apart from the fixed underlying surface. The transport surface can be configured so as to run perpendicular to the vertical axis, radially with respect to the vertical axis and/or obliquely, i.e. tapered. In preferred manner, the receiving container has a fixed supporting structure which is in contact with the transport surface. The supporting structure can be internal, that is to say inside the interior space enclosed by the side wall of the receiving container, and can be recessed with respect to a lower edge of the receiving container, that is to say set back towards an upper filling opening of the receiving container. The supporting structure can comprise a fixed container base which divides the interior space of the receiving container into a filling space, which is open towards the top, for receiving the fibre sliver and an equipment space, which is open towards the bottom, in which the vehicle is installed. The receiving container can therefore have been as it were put over the vehicle from above. In the filling space there can be arranged, in a manner known per se, a plate, especially a spring-loaded plate, which is able to sink down towards the container base under the weight of the column of fibre sliver that accumulates during the coiling. In the case of the can device, the underside of the container base can be in contact, especially direct contact, with the transport surface. In particular, the receiving container can be supported on the transport surface by way of the container base. The supporting structure can also have one or more struts, supports, a rim or the like and can form a beam-like, net-like or ring-shaped supporting surface. Especially in the case where the transport surface is aligned radially with respect to the vertical axis, the receiving container can have its container base in contact with the transport surface and can be clamped against the transport surface by means of the fastening means, so that no further supporting structure is required. However, the supporting structure can comprise, for example, a ring-shaped rib in the interior of the receiving container, which rib is supported on a horizontal portion of the transport surface in order to be better able to absorb weight forces. The supporting structure accordingly need not provide dust-free separation between the filling space and the equipment space. Rather, it can be advantageous if smaller sliver oddments that collect in the filling space or other contaminants are able to drop downwards through the equipment space and fall onto the underlying surface. If the supporting structure comprises the container base, which can generally be formed as a disc, the container base can have at least one hole and, more preferably, a plurality of eccentrically located holes. The holes in the container base or openings in the supporting structure can be positioned in such a way that the contaminants fall out in the radially outer edge region of the vehicle and preferably outside the function portion and especially passing by the on-board electrical system. For example, the contaminants can be discharged in the pivot region of the spring-mounted support wheel or the support wheels. Also conceivable in principle, however, is separation of the filling space from the equipment space in as dust-free a manner as possible in order to keep the vehicle as free of fibre sliver residues as possible. Instead of the fixed container base, which is customarily used in the case of round cans, the receiving container can also have a height-adjustable filling base, which is often used in the case of rectangular cans, and can have the supporting structure. The base plate can be matched to the cross-section of the interior space of the rectangular can. If the receiving container has the shape of a “rectangular can”, a device can be provided for discharging the contaminants that fall out of the filling space, which device is arranged underneath the movable base and guides the contaminants laterally into the outer edge region, from where they can then fall onto the underlying surface.

In particular, the receiving container and the vehicle can be connected to one another by means of fastening means, the fastening means comprising the vehicle-side fastening elements and the container-side fastening elements. In accordance with a first configuration, the fastening means can be entirely covered by the receiving container. Accordingly, they are not accessible from the outside during operation of the self-driving can device, as in the case of a blind fastening, unless the can device is placed “on its head”. The container-side fastening elements can be arranged entirely in the equipment space and can project into the equipment space parallel to the container axis of the receiving container. The container-side fastening elements, for example bolts, threaded pins or the like, can be arranged, especially integrally formed, on the underside of the supporting structure. They can be inserted into the vehicle-side fastening elements, for example through-bores, and can then be secured. Preferably, nuts are provided which are screwed onto the container-side fastening elements in order to clamp the supporting structure and the vehicle body, for example the base plate thereof, against one another. Furthermore, the vehicle-side fastening elements can comprise, for example, bolts, threaded pins or the like, which project upwards from the vehicle body, especially from the base plate, beyond the transport surface and extend into or through complementary bores in the receiving container. In that way a blind fastening can likewise be provided. In accordance with a second configuration, which can additionally or alternatively apply to the first configuration, the vehicle-side fastening means can project from the vehicle body radially with respect to the vertical axis. These can be, for example, ribs, bolts, threaded pins or the like, which protrude through openings in the side wall of the receiving container. The side wall and the transport surface can be clamped against one another by means of nuts. It equally applies in respect of the configurations that, in the installed state, the container axis of the receiving container can coincide with the vertical axis, or the yaw axis, of the vehicle.

In preferred manner, the vehicle is housed at least substantially in the equipment space. “At least substantially” is intended to include that firstly, as described above, individual components can project laterally beyond the receiving container and, secondly, the wheels project on the underside of the receiving container in order to ensure sufficient ground clearance. The vehicle can have an overall height of at least 50 millimetres and of at most 260 millimetres. The overall height can be determined by the spacing between the wheel contact plane and a support plane defined by the transport surface. In particular, the vehicle has no components in the support plane outside the transport surface. In the installed state, the vehicle can project at least 10 millimetres and at most 40 millimetres beyond the underside of the receiving container. The equipment space can have a depth, i.e. an extent in the vertical direction, of at least 60 millimetres and at most 220 millimetres. Accordingly, the equipment space is on the one hand sufficiently deep to be able to receive the vehicle. On the other hand, the filling volume of the receiving container is only negligibly reduced. Accordingly, the height of the self-driving can device can correspond to the height of a standard can, so that the can device can be used without operational adjustments to the textile machines. Alternatively, the supporting structure, especially the container base, can also finish flush with the underside of the receiving container, as in the case of a sleeve. As a result, the receiving container can be produced more cost-effectively. Since the receiving container then does not have an equipment space, a circumferential collar can be arranged laterally on the vehicle body in order to protect the vehicle, which collar can be flush with the side wall of the receiving container in the installed state.

Advantageously, the on-board electrical system is also covered by the receiving container, although there may be technical requirements which mean that individual components are to be arranged also outside the region covered by the receiving container. For example, such a component may be the radio module in order to improve the quality of the radio connection to a higher-level master controller.

In particular, the receiving container has a filling opening, which is open towards the top, for the fibre sliver. In the case of a receiving container in the form of a “round can”, the footprint can be circular and in the case of a “rectangular can” accordingly rectangular.

### BRIEF DESCRIPTION OF THE DRAWINGS

Preferred embodiments are explained below with reference to the Figures in the drawings, wherein:

FIG. 1 shows a front view of a can device in accordance with a first embodiment of the present invention situated on an underlying surface, the can device being of modular construction and having a receiving container according to the invention and a vehicle according to the invention for transporting the receiving container over the underlying surface;

FIG. 2 shows a rear view of the can device from FIG. 1;

FIG. 3 shows a simplified sectional view of the can device from FIG. 1;

FIG. 4 shows a sectional view of the receiving container from FIG. 1;

FIG. 5 shows the receiving container from FIG. 1 in a view from below;

FIG. 6 shows a plan view of the vehicle from FIG. 1, wherein, merely to illustrate the relative sizes, a base of the receiving container is indicated by a dotted line;

FIG. 7 shows the vehicle from FIG. 1 in a view from below, wherein, merely to illustrate the relative sizes, a base of the receiving container is indicated by a dotted line;

FIG. 8 shows a cross-sectional view of the vehicle from FIG. 1, wherein the vehicle is shown on the underlying surface;

FIG. 9 shows a diagrammatic view of an on-board electrical system of the vehicle from FIG. 1;

FIG. 10 shows the can device from FIG. 1 in a view from below, the can device being located on a straight route section, which is indicated by dashed lines;

FIG. 11 shows the can device from FIG. 10, the can device being located on the straight route section shortly before a curved route section;

FIG. 12 shows the can device from FIG. 11, the can device being located on the curved route section;

FIG. 13 shows the can device from FIG. 1 in a view from below, the can device being located on a straight route section shortly before a junction of the route, which is indicated by dashed lines;

FIG. 14 shows the can device from FIG. 13, the can device being located over the junction and performing a right turn;

FIG. 15 shows the can device from FIG. 14 over the junction after the 90 degree right turn;

FIG. 16 shows a perspective side view of an embodiment of a spring-mounted support wheel of the vehicle according to the invention; and

FIG. 17 shows a sectional view of an alternative embodiment of the spring-mounted support wheel of the vehicle according to the invention.

### DETAILED DESCRIPTION

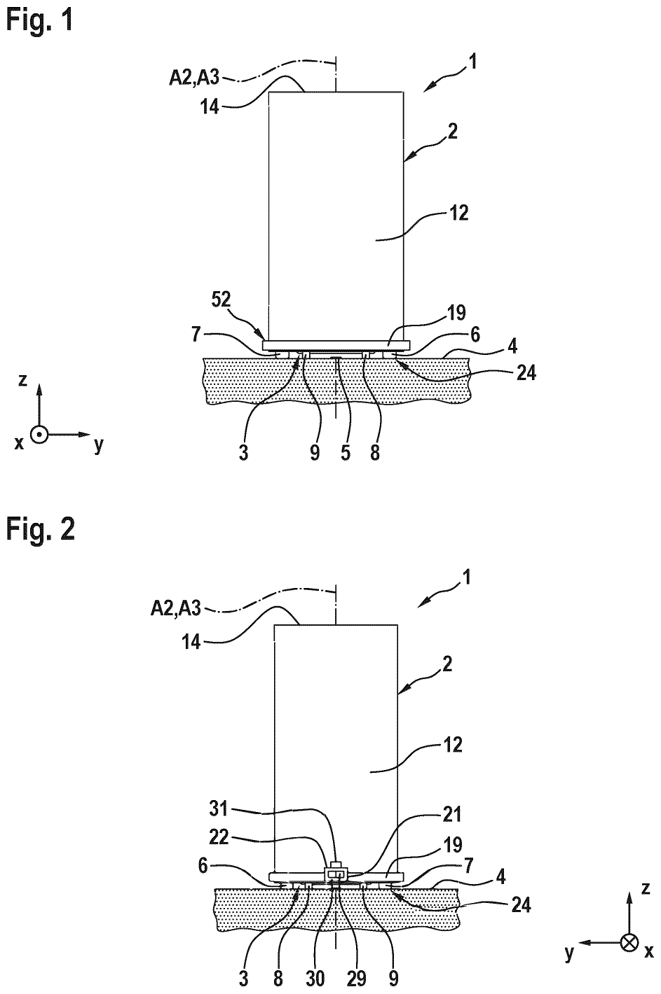

FIGS. 1 to 3 show a can device 1 in accordance with an embodiment of the present invention. The can device 1, which can also be referred to as a self-driving can, is of modular construction and has, as first module, a receiving container 2 according to the invention for a fibre sliver and, as second module, a self-driving vehicle 3 according to the invention for transporting the receiving container 2 over an underlying surface 4.

During operation, the can device 1 travels back and forth on the underlying surface 4 between textile machines (not shown) in order to transport fibre slivers from sliver-delivering textile machines to sliver-fed textile machines. For that purpose, the vehicle 3 is able to follow guide elements 5 which are arranged on the underlying surface 4 and specify routes in the spinning room. As shown in FIGS. 1 to 3, the guide elements 5 can have been applied, especially adhesively bonded, to the surface of the underlying surface 4 or can be embedded in the underlying surface 4. For example, slots and/or apertures of some other shape can be formed in the underlying surface 4, in which the guide elements 5 can be installed and then covered with epoxy resin or the like.

In order to illustrate the orientation of the can device 1 in space, FIGS. 1 to 3 show a longitudinal direction X, a transverse direction Y and a vertical direction Z which are defined in terms of a Cartesian coordinate system assigned to the can device 1 and indicated by corresponding arrows. The vertical direction Z can be normal to a floor plane defined by the underlying surface 4 when the can device 1 is standing or travelling on the underlying surface 4. Terms such as “bottom”, “below”, “top” or “above” are spatial details relating to the can device 1 situated on the underlying surface 4.

The vehicle 3 has been installed in the receiving container 2 from below, its wheels 6, 7, 8, 9 projecting on a container underside 10 of the receiving container 2. For sufficient ground clearance, a spacing S2 between the receiving container 2 and the underlying surface 4 is between 10 millimetres and 50 millimetres, with especially good results having been obtained with a spacing S2 of about 20 millimetres.

The receiving container 2 is in principle detachable but is permanently connected to the vehicle 3. That state is also referred to as the “installed state” and is shown in FIGS. 1 to 3. Specifically, fastening means 11 are provided which are not accessible from the outside unless the can device 1 is placed “on its head”. In that respect the fastening means 11 can also be referred to as internal fastening means which provide a blind fastening.

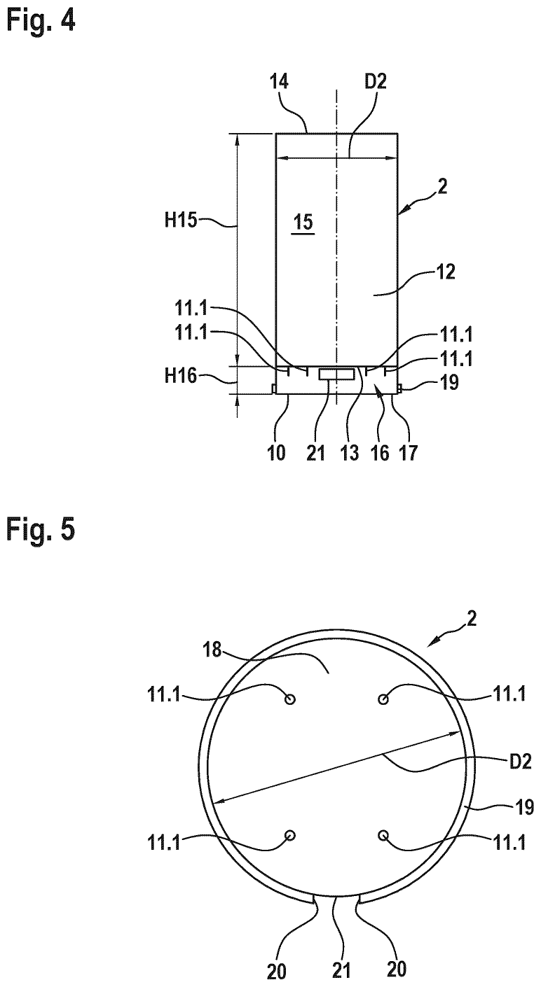

FIGS. 4 and 5 show the receiving container 2 according to the invention in detail. The receiving container has a cylindrical side wall 12 which extends concentrically around a container axis A2 that runs parallel to the vertical axis Z. An internal diameter D2 of the interior space enclosed by the side wall 12 is at least 350 millimetres and at most 1200 millimetres and is, here by way of example, 500 millimetres. Furthermore, the receiving container 2 has a supporting structure 13, which is here configured as a fixed container base in the form of a circular disc, the external diameter of which corresponds at least substantially to the internal diameter D2. The supporting structure 13, which is also referred to as the container base hereinbelow, is arranged in a recessed position and is rigidly connected to the side wall 12. “Arranged in a recessed position” means here that the container base 13 is arranged displaced away from the container underside 10 towards an upper side of the receiving container 2, which upper side is provided with a filling opening 14. The container base 13 therefore divides the interior space into a filling space 15, which is open towards the top, and an equipment space 16, which is open towards the bottom. By means of the filling opening 14, the fibre sliver can be introduced into the filling space 15 and removed again therefrom in a manner known per se. In the filling space there can be arranged, for example, a plate known per se (not shown) which can be, for example, spring-loaded and which is able to sink down towards the container base 13 under the weight of the column of fibre sliver that accumulates during the coiling. On the container underside 10 there is provided a container opening 17 which can be aligned parallel to the filling opening 14 and through which the vehicle 3 can be installed in the equipment space 16 from below. An internal diameter of the container opening 17 can correspond to the internal diameter D2 of the interior space, although in principle it can also be smaller, provided that the vehicle 3 can still be installed in the equipment space 16.

The equipment space 16 has an extent H16 in the vertical direction Z of, for example, at least 50 millimetres and at most 260 millimetres and has, here by way of example, an extent of 110 millimetres. The filling space 15 has an extent H15 in the vertical direction Z of, for example, at least 400 millimetres and at most 1500 millimetres and has, here by way of example, an extent of 1200 millimetres. Accordingly, the filling volume of the filling space 15 is, here, about 339 litres.

In the installed state, the receiving container 2 is supported by its container base 13 on the vehicle 3. For fastening the receiving container 2 to the vehicle 3, the fixing means 11 comprise container-side fastening elements 11.1, which have, for example, threaded bolts 11.1 aligned parallel to the container axis A2, onto which nuts 11.3 can be screwed. The, here by way of example four, threaded bolts 11.1 can be formed integrally with, especially welded to, a base underside 18 of the container base 13, which base underside faces towards the equipment space 16, as can be seen in the view from below according to FIG. 5.

Furthermore, a bumper 19 is arranged on the receiving container 2. The bumper is arranged in the circumferential direction around the container axis A2 on the outer side of the side wall 12. In FIG. 5 it can also be seen that the bumper 19 has a c-shaped open ring shape having two ring ends 20. A wall opening 21 is formed in the side wall 12 between the two ring ends 20, which wall opening is located on the rear side of the receiving container 2. FIG. 2 shows the rear view of the can device 1, from which it can be seen that an electrical housing 22 of the vehicle 3 extends through the wall opening 21 and projects laterally beyond the bumper 19. Alternatively, the bumper 19 can also be arranged on the vehicle 3 if the receiving container 2 is designed in the form of a sleeve where the container underside 10 of the receiving container 2 finishes flush with the container base 13. The alternative embodiment is shown in FIG. 19 and will be discussed in greater detail hereinbelow.

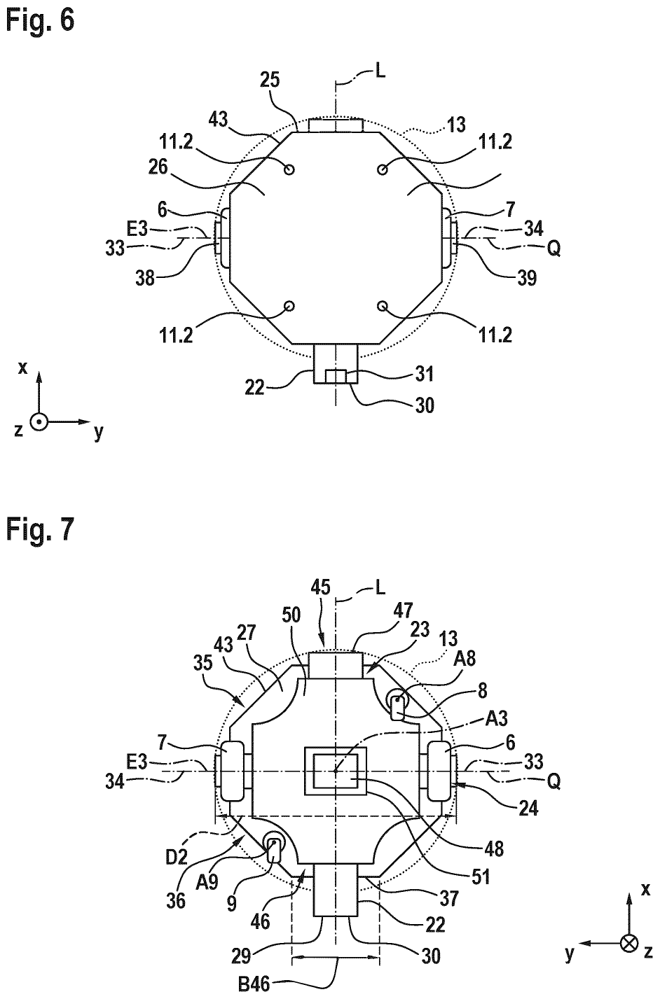

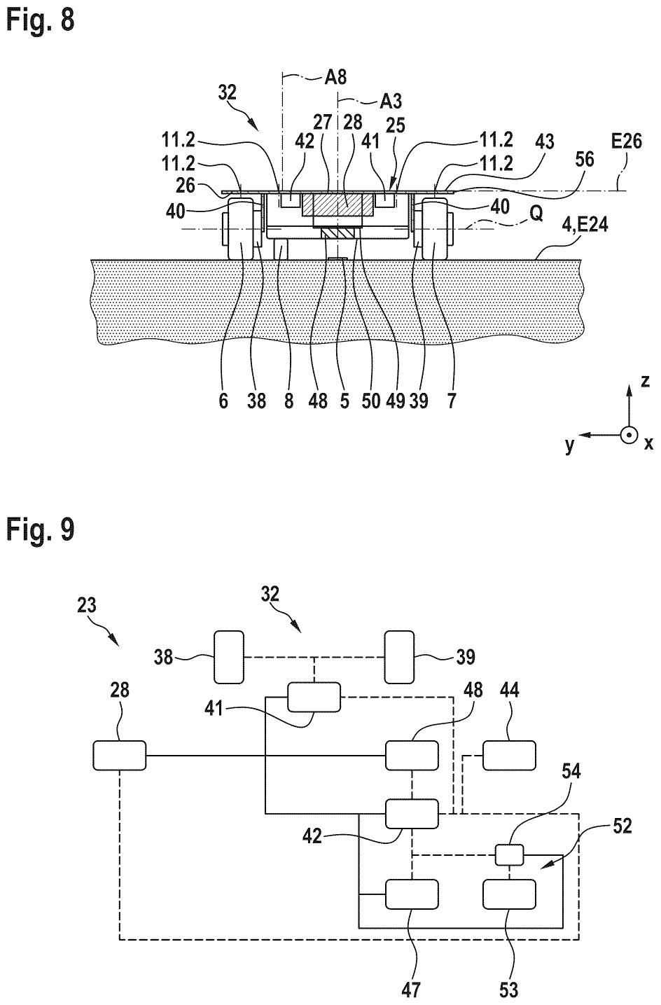

FIGS. 6 to 8 show the vehicle 3 according to the invention in detail, the circular contour of the container base 13 being indicated by dotted lines in FIGS. 6 and 7 merely in order to illustrate that, in the installed state, the vehicle 3 is substantially covered by the receiving container 2, or by the container base 13. It will be seen that only the electrical housing 22 as well as some components of an on-board electrical system 23 of the vehicle 3 that are arranged in or on the electrical housing 22 are located outside, or project beyond, the covered region.

Specifically, the vehicle 3 has an undercarriage 24 having the four wheels 6, 7, 8, 9, a vehicle body 25 supported by the undercarriage 24, a transport surface 26 with which the container base 13 of the receiving container 2 can be brought into contact, and the on-board electrical system 23 arranged on the vehicle body 25. Furthermore, the vehicle body 25 has a rigid base plate 27, the upper side of which, facing away from the undercarriage 24, comprises the transport surface 26. The base plate 27 has a circumferential surface 56 running around the yaw axis A3, which circumferential surface is configured so as to be exposed radially towards the outside and defines an outer edge 43 of the base plate 27. The transport surface 26 extends as far as the outer edge 43 of the base plate 27. The transport surface 26 lies in a support plane E26 which is parallel to the longitudinal direction X and to the transverse direction Y and to which a yaw axis A3 of the vehicle 3 is normal. The yaw axis A3 corresponds to the vertical axis of the vehicle. It is advantageous if the yaw axis A3 runs through the centre point or centre of gravity of the vehicle 3. The on-board electrical system 23 is arranged entirely underneath the support plane E26.

For fastening the receiving container 2 to the vehicle 3, the fastening means 11 further comprise vehicle-side fastening elements 11.2 which co-operate with the container-side fastening elements 11.1, i.e. they are oriented relative to one another, in such a way that in the installed state a container axis A2 of the receiving container 2 and the yaw axis A3 of the vehicle 3, which yaw axis is fixed relative to the vehicle, coincide. The vehicle-side fastening elements 11.2 can comprise through-bores which are formed in the base plate 27 and especially in the region of the transport surface 26 and into which the container-side threaded bolts 11.1 are insertable. In the installed state, the threaded bolts 11.1 are installed in the through-bores 11.2 and the nuts 11.3 are screwed onto the threaded bolts 11.1 from below in order to clamp the container base 13 and the base plate 27 against one another.

The on-board electrical system 23 is shown diagrammatically in FIG. 9. It has an electrical energy storage means 28, which is permanently installed in the vehicle 3, especially a battery, and a charging interface 29 for charging the energy storage means 28 at an external charging station. It will be understood that the energy storage means 28 can be exchanged in the event of a defect. The charging interface 29 can be arranged in the electrical housing 22 so as to be accessible from the outside. The electrical housing 22 is mounted on the vehicle body 25 and can be made from a dimensionally stable plastics material. Preferably, the electrical housing 22 has a concave end face 30. The curvature of the end face 30 is at least approximately the same as, but opposite to, the curvature of the side wall 12. This is advantageous if the can device 1 comes into contact with another can device 1 or with a standard can, because the other can will be able to rest against the curved end face 30. This may be the case, for example, in a can changer if the can device 1 is pushed against another can (“can against can” principle). Furthermore, an on/off switch 31 can be arranged on the electrical housing 22 so as to be accessible from the outside in order that the power supply between the energy storage means 28 and the other components of the on-board electrical system 23 can be interrupted manually.

Furthermore, the on-board electrical system 23 comprises an electrically operated drive unit 32, which, here by way of example, is in driving connection with the wheels 6, 7. The two wheels 6, 7 are in the form of fixed wheels which are aligned in the longitudinal direction X and are arranged spaced apart from one another in the transverse direction Y. They have rotational axes 33, 34 which are fixed in relation to the vehicle body 25 and lie on a notional straight line to which the yaw axis A3 of the undercarriage 3 is normal. It can be seen in FIGS. 6 and 7 that the notional straight line and the diagonal D2 of the container base 13 indicated by a dashed line are parallel to one another and lie in a common plane. The notional straight line divides the vehicle body 25 in the longitudinal direction X into a front portion 35 and a rear portion 36. The two portions 35, 36 can be of equal size, so that the notional straight line lies in a centre plane E3 defined by the vehicle transverse axis Y and the yaw axis A3. The vehicle body 25 can be symmetrical with respect to the centre plane E3. The electrical housing 22 is mounted on the rear portion 36 and projects beyond a rear edge 37 of the vehicle body 25.

The drive unit 32 comprises electric motors 38, 39, especially a wheel hub motor, for each fixed wheel 6, 7. The electric motors 38, 39 in the form of wheel hub motors can be integrated in the fixed wheels 6, 7. The electric motors 38, 39 are arranged on housing struts 40 of the vehicle body 25 that project from the base plate 27, so that the fixed wheels 6, 7 remain behind the support plane E26. Furthermore, the drive unit 32 has, here by way of example, a servo converter for each electric motor 38, 39, which servo converters are here structurally combined in a double converter 41. Instead of servo converters it would also be possible to use frequency converters or other means for achieving the assigned rotational speed of the electric motors 38, 39. The double converter 41 is connected to the two electric motors 38, 39 and to the electrical energy storage means 28. By means of the double converter 41 it is possible for the two electric motors 38, 39 to be operated in the same or opposite directions and at the same or different rotational speeds to one another. The vehicle 3 can thereby be steered and, in the case of actuation in opposite directions, also turned on the spot, that is to say about the yaw axis A3. To control the electric motors 38, 39, the double converter 41 is connected to a control unit 42 of the on-board electrical system 23.

The control unit 42, which is a memory-programmable controller having a programmable storage medium, is configured for controlling the vehicle 3. Here by way of example it is in the form of a single device and is housed in a control housing. The control housing is fastened to the vehicle body 25, especially to the underside of the base plate 27. For monitoring the energy storage means 28, the on-board electrical system 23 can have a battery management system. For that purpose, the control unit 42 can be connected to the energy storage means 28. For communication with a higher-level master controller, with a textile machine or with a mobile device (smartphone, tablet, etc.), the control unit 42 can be connected to a radio module 44, which can be housed in the electrical housing 22.

Furthermore, the on-board electrical system 23 has a reading unit 45 (see FIG. 7), in the form of a tape reading device 47 shown in FIGS. 7 and 9 which is configured for detecting the guide elements 5 arranged on the underlying surface. The reading unit 45 is preferably arranged exclusively on a function portion 46 of the vehicle body 25, which function portion is formed in the transverse direction Y between the two fixed wheels 6, 7. The function portion 46 has a width B46, i.e. an extent in the transverse direction Y, of at least 250 millimetres and at most 1200 millimetres and extends in the longitudinal direction X over the front portion 35 and the rear portion 36. The vehicle 3 is thus dimensioned for the transport of the receiving container 2 which, here, is configured as a “round can”. In order to be installable on a receiving container 2 in the form of a “rectangular can”, the vehicle 3 should be dimensioned correspondingly smaller. In that case the function portion 46 can also have a width of at least 150 millimetres and at most 1200 millimetres.

The reading unit 45 comprises a magnetic tape reading device 47, which is configured for contactlessly detecting the course of guide elements 5 in the form of magnetic tapes 5.1. The magnetic tape reading device 47, which can also be referred to as a magnetic scanner, is arranged at an end of the vehicle body 25 that is located at the front in the main direction of travel (forward travel), i.e. in the longitudinal direction X. The magnetic tape reading device 47 has a sensor housing in which a plurality of sensors, for example eight sensors, are arranged spaced apart from one another in the transverse direction Y. The sensor housing can have a width, i.e. an extent in the transverse direction Y, of between 50 millimetres and 200 millimetres. The spacing of the sensors from the underlying surface, i.e. from a wheel contact plane E24 defined by the wheels 6, 7, which plane coincides with the floor plane during travel over the underlying surface 4, can be between 20 millimetres and 50 millimetres. The width of the magnetic strips can be between 6 and 50 millimetres. Furthermore, the reading unit 45 has a RFID tag reading device 48 which is configured for reading out information from guide elements 5 in the form of RFID tags 5.2. The RFID tag reading device 48 can also be referred to as a RFID reader. The RFID tag reading device 48 is arranged below the base plate 27 on a frame 49, which is fastened to the base plate 27, in order that, during operation of the vehicle 3, the RFID tag reading device 48 is kept closely above the underlying surface 4, especially above the guide elements 5.2. The frame 49 engages around, here, the energy storage means 28, which is accordingly arranged between the base plate 27 and the RFID tag reading device 48 in the vertical direction Z. By means of the RFID tag reading device 48, address information, for example, can be read out from the RFID tags 5.2 and transmitted to the control unit 42. The RFID tags 5.2 usually have a diameter of less than 50 millimetres. To protect the on-board electrical system 23, an underbody panel 50 is arranged on the vehicle body 25 from below, which underbody panel can have an opening 51 in the region of the RFID tag reading device 48.

The vehicle 3 has an overall height H3 of, here by way example, 140 millimetres. The transport surface 26 finishes the vehicle 3 towards the top. Accordingly, the overall height H3 is determined by the spacing of the transport surface 26 from the underlying surface 4, i.e. from the wheel contact plane E24. The vehicle 3 therefore has a compact design such that, in the installed state, it at least substantially disappears below the receiving container 2, or below the container base 13 thereof. Only individual components, especially from the on-board electrical system 23, are able to project laterally beyond the container base 13, because there is a technical necessity therefor. Those components can be, for example, the charging interface 29, the on/off switch 31 and the radio module 44, which are arranged in or on the electrical housing 22. In the installed state, the undercarriage 24, the electrical drive unit 32, the electrical energy storage means and the transport surface 26 are therefore entirely covered. Furthermore, as can be seen in FIGS. 1 to 8, the receiving container 2, or its container base 13, can also entirely cover the base plate 27 as well as the fastening elements 11 and can at least substantially cover the on-board electrical system 23. Of the on-board electrical system 23, in particular the control unit 42 and the reading unit 45 can be covered.

It can be seen inter alia in FIG. 7 that the wheels 8, 9 are also arranged between the two fixed wheels 6, 7 in the transverse direction Y and eccentrically in relation to the longitudinal axis L of the vehicle and are supported on the vehicle body 25. The support wheels 8, 9 therefore roll over the underlying surface 4 outside the track of the fixed wheels 6, 7. Their transverse spacing from the longitudinal axis L of the vehicle is, here by way of example, about 90 millimetres in each case, so that the two wheels 8, 9 are spaced about 180 millimetres apart from one another in the transverse direction Y. The function portion 46 is formed between the support wheels 8, 9 and is accordingly free of the wheels 6, 7, 8, 9 in order to protect the guide elements 5 during operation of the can device 1. In principle, however, it is also possible for the wheels 8, 9 to be arranged centrally, that is to say on the longitudinal axis L of the vehicle.

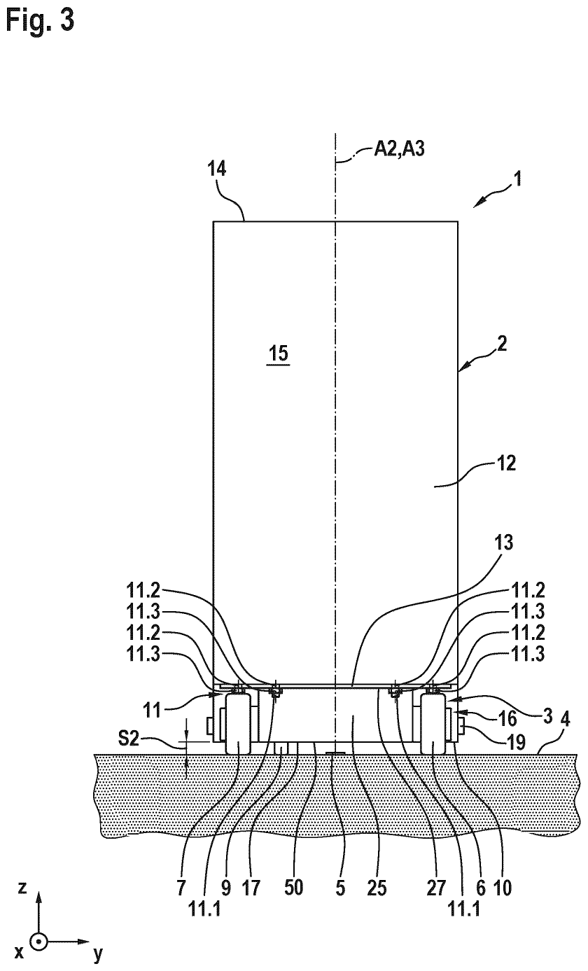

The wheels 8, 9 are in the form of support wheels which are each mounted on the vehicle body 25 so as to be pivotable about its own pivot axis A8, A9 which is aligned parallel to the vertical axis Z. The support wheels 8, 9 can be freely pivotable about the pivot axes A8, A9, so that they are able to pivot through 360 degrees and more. Support wheel 8, which can also be referred to as the leading support wheel, is supported on the front portion 35 and support wheel 9, which can also be referred to as the trailing support wheel, is supported on the rear portion 36. The leading support wheel 8 is not spring-mounted and the trailing support wheel 9 is spring-mounted on the vehicle body 25. The suspension of the spring-mounted support wheel 9 therefore provides that the wheel is mounted on, or supported against, the vehicle body 25 so as to be movable parallel to the vertical axis of the vehicle. To improve the stability of the vehicle 3, the support wheels 8, 9 can be arranged as far as possible to the outside on the vehicle body 25 and, as shown merely by way of example by the dotted line 57 in FIG. 3, can lie on a notional circular line. In principle, however, it is also possible for the support wheels 8, 9 to be arranged at different spacings to one another from the centre plane E3 in which the two rotational axes 33, 34 lie. It is advantageous if the centre of gravity of the vehicle 3 lies in the centre plane E3, in which the transverse axis Q of the vehicle also runs, or at least as close as possible to the yaw axis A3. This improves the stability of the can device 1 during rotation on the spot. To further improve the stability, two further support wheels (not shown) can be provided. For example, a second non-spring-mounted support wheel can be arranged on the front portion 35 and a second spring-mounted support wheel can be arranged on the rear portion 36. The two further support wheels can be arranged on the notional circular line and in extension of the respective support wheel 8, 9.

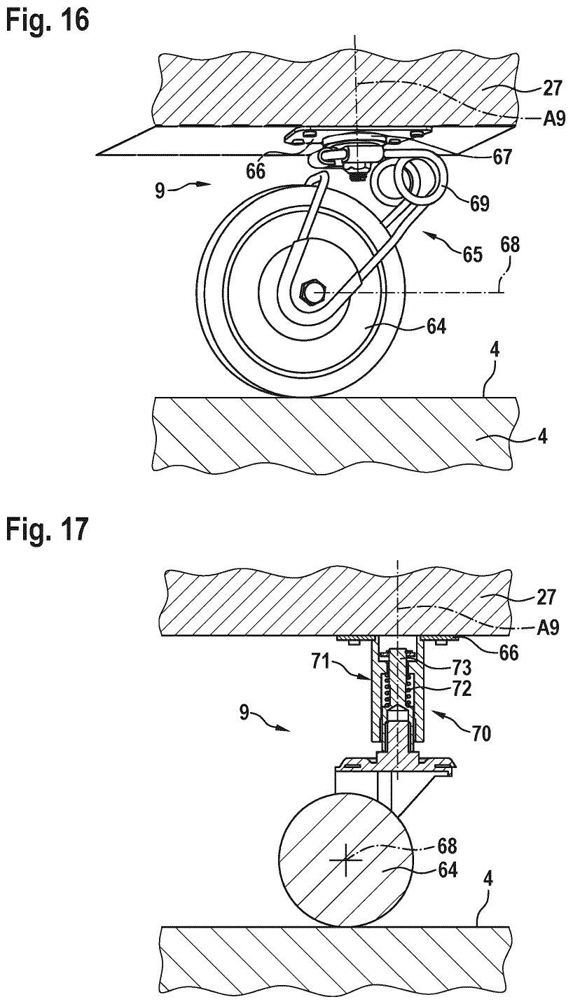

FIG. 16 shows the spring-mounted support wheel 9 which, like the non-spring-mounted support wheel 8, has a castor 64 which is mounted so as to be rotatable about a rotational axis 68 aligned perpendicular to the pivot axis A9. The castor 64 of the spring-mounted support wheel 9 is supported on the vehicle body 25 via a spring arrangement 65. The spring arrangement 65 therefore enables the castor 64 to be mounted on, or supported against, the vehicle body 25 so as to be movable parallel to the vertical axis of the vehicle. Between the vehicle body 25 and the spring arrangement 65 there is arranged a bearing 67, which can be, for example, a thrust bearing, and a holding plate 66 with which the support wheel 9 is fastened, for example screwed, to the vehicle body 25. By means of the bearing 67, the support wheel 9, especially the castor 64 supported on the vehicle body 25 via the spring arrangement 65, is freely pivotable about the pivot axis A9.

FIG. 17 shows in longitudinal section an embodiment of the spring-mounted support wheel 9 alternative to FIG. 16. The spring arrangement 70 has a spring damper element 71 having a coil spring 72 and a piston 73. Accordingly, the spring arrangement 70 also enables the castor 64 to be mounted on, or supported against, the vehicle body 25 so as to be movable parallel to the vertical axis of the vehicle. The castor 64 of the support wheel 9, which is freely pivotable about the pivot axis A9, is mounted so as to be rotatable about the rotational axis 68 aligned perpendicular to the pivot axis A9.

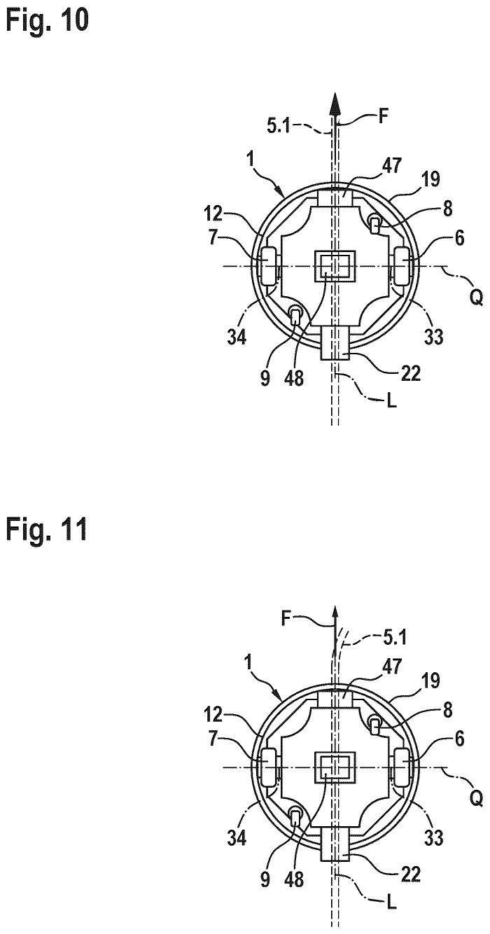

FIGS. 10 to 15 show various situations which can arise during operation of the can device 1 or the vehicle 3 during travel over the underlying surface 4 along the guide elements 5. In order to be better able to illustrate the travel behaviour of the vehicle 3, the underside of the vehicle 3 is shown seen from below through the underlying surface 4 which is shown as transparent for ease of viewing. The guide elements 5 arranged on the underlying surface 4 are indicated by dashed lines.

During travel in the main direction of travel (forward travel), which is indicated by arrow F in FIG. 10, the vehicle 3 follows the magnetic tape strip 5.1. For that purpose, the control unit 42 controls the electric motors 38, 39 on the basis of the signals received from the magnetic tape reading device 47 located at the front in the main direction of travel F in order to keep the magnetic tape strip 5.1 central between the two fixed wheels 6, 7. During travel straight ahead, the two electric motors 38, 39 are operated in the same direction and at the same rotational speed. The support wheels 8, 9 are likewise aligned in the main direction of travel F.

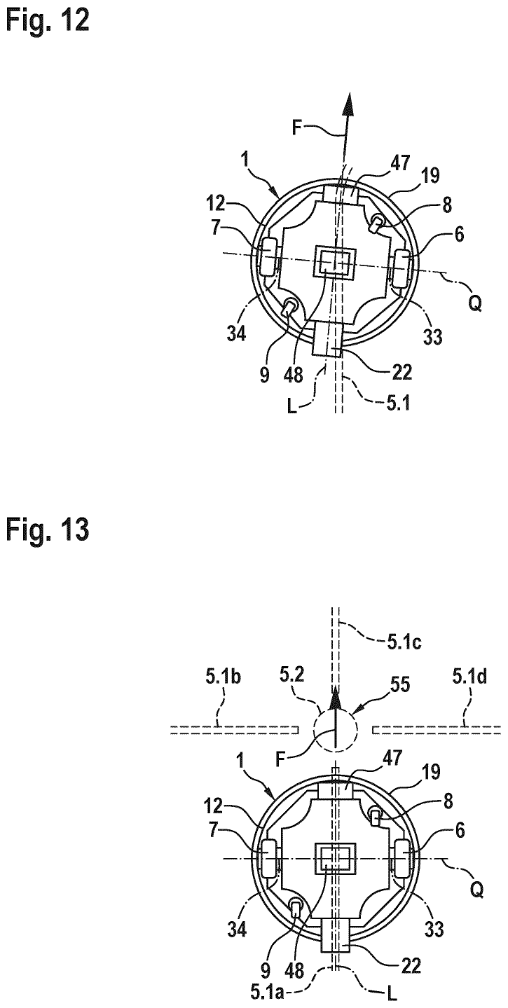

In FIG. 11, the vehicle 3 is approaching a right-hand curve specified by the magnetic tape strip 5.1, the vehicle 3 still travelling straight ahead. As soon as the magnetic tape strip 5.1 departs from the centre of the sensor field of the magnetic tape reading device 47 (centre deviation), the sensor coverage pattern changes. It can be seen in FIG. 12 that the magnetic tape strip 5.1 now moves into the detection region of the sensors of the magnetic tape reading device 47 that are arranged towards the inner side of the curve. On the basis of the sensor coverage pattern, which changes during travel, the control unit 41 is able to determine to what extent adjustments need to be made in order to keep the vehicle 3 as central as possible over the magnetic tape. This is effected by adjusting the rotational speeds of the electric motors 38, 39 relative to one another. The more the magnetic tape strip 5.1 departs from the centre, the greater must be the difference in the rotational speeds. The freely pivotable support wheels 8, 9 follow the direction of travel. The vehicle 3 is therefore steered only via changes in the rotational speeds of the electric motors 38, 39.

In FIG. 13, the vehicle 3 is approaching a junction 55 at which, here by way of example, four paths meet, those paths being specified by four magnetic tape strips 5.1a, b, c, d. In the centre of the junction 55 there is arranged a RFID tag 5.2 from which the magnetic tape strips 5.1 are spaced apart. The RFID tag 5.2 stores address information which renders the junction 55 unambiguously identifiable. The vehicle 3 will continue to travel straight ahead until the RFID tag reading device 48 detects the RFID tag 5.2. In order to prevent the control unit 42 from searching for the magnetic tape strip 5.1 by means of steering movements on account of the spacing of the magnetic tape strip 5.1a from the RFID tag 5.2, it is possible for a delay to be stored in the control unit 42, which delay is sufficiently long (for example 1-2 seconds) that the vehicle 3 continues to travel straight ahead until the RFID tag reading device 48 detects the RFID tag 5.2. The read-out RFID data are transmitted to the control unit 42, in which a fixed route can be stored. The control unit 42 can likewise also communicate with a higher-level master controller and receive up-to-date travel instructions, so that the vehicle 3 can be controlled as needed.

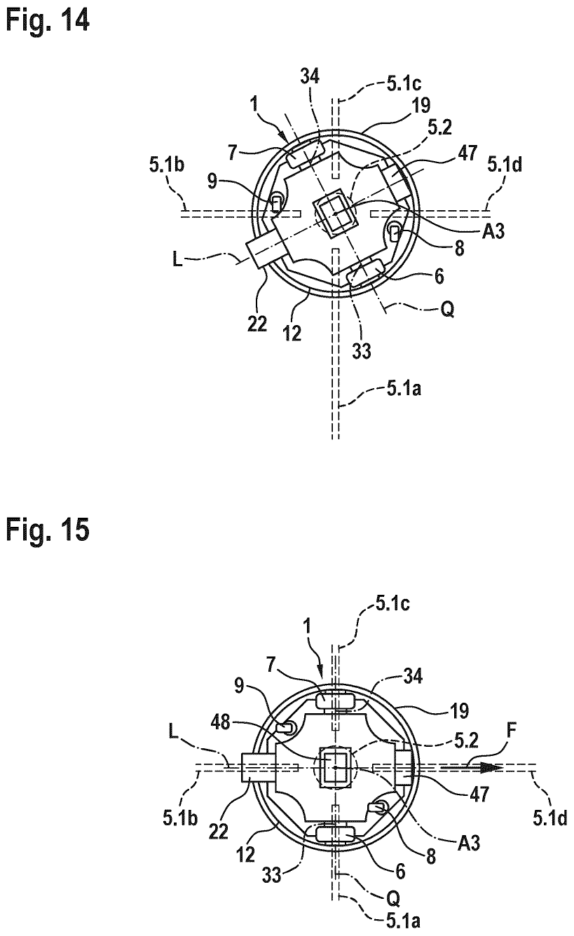

In the situation shown in FIG. 14, the control unit 42 has specified a left turn in order to turn off at junction 55. The control unit 42 turns the vehicle 3 at the junction 55 by actuating the electric motors 38, 39 in opposite directions of rotation. The left-hand electric motor 38 turns the left-hand fixed wheel 6 backwards and the right-hand electric motor 39 turns the right-hand fixed wheel 7 forwards. The vehicle 3 turns on the spot about its yaw axis A3 and therefore remains over the centre of the junction 55. During the entire turning operation, the RFID tag reading device 48 keeps the RFID tag 5.2 in the detection region, i.e. below itself. After performing the 90 degree turn, the vehicle 3 follows the magnetic tape strip 5.1d in the main direction of travel F until it arrives at a further RFID tag. Instead of the 90 degree turn shown here, any other angle of rotation is also possible. A route can end in a textile machine, a charging station, a can magazine or the like, which can be identified by means of RFID tags.

The above-described layout of the magnetic tape strips 5.1a . . . 5.1d, which are spaced apart from one another at junction 55, has the advantage that the paths specified by the guide elements 5 can be traversed in both directions. If that is undesirable because a defined path direction, as in the case of a one-way street, is to be specified, for example in order to avoid a collision, then it is also possible to provide at junction 55 a continuous magnetic tape strip which extends without interruption over, for example, magnetic tape strips 5.1a and 5.1c. The RFID tag 5.2 can in that case be applied to the magnetic tape strip 5.1a, 5.1c.

If the vehicle 3 or the can device 15 ascends a ramp (not shown), the suspension of the trailing spring-mounted support wheel 9 is able to compress. As a result, the driven fixed wheels 6, 7 maintain contact with the floor, so that inclined surfaces can also be traversed independently.

Reference signs

| | | | |
|---|---|---|---|
| 1 | can device | 44 | radio module |
| 2 | receiving container | 45 | reading unit |
| 3 | vehicle | 46 | function portion |
| 4 | underlying surface | 47 | magnetic tape reading device |
| 5 | guide element | 48 | RFID tag reading device |
| 6 | wheel, or fixed wheel | 49 | frame |
| 7 | wheel, or fixed wheel | 50 | underbody panel |
| 8 | wheel, or support wheel | 51 | opening |
| 9 | wheel, or support wheel | 52 | safety device |
| 10 | container underside | 53 | contact sensor |
| 11 | fastening means | 54 | safety relay |
| 12 | side wall | 55 | junction |
| 13 | supporting structure | 56 | circumferential surface |
| 14 | filling opening | 57 | circular line |
| 15 | filling space | 64 | castor |
| 16 | equipment space | 65 | spring arrangement |
| 17 | container opening | 66 | holding plate |
| 18 | base underside | 67 | bearing |
| 19 | bumper | 68 | rotational axis |
| 20 | ring end | 69 | double-leg spring |
| 21 | wall opening | 70 | spring arrangement |
| 22 | electrical housing | 71 | spring damper element |
| 23 | on-board electrical system | 72 | coil spring |
| 24 | undercarriage | 73 | piston |
| 25 | vehicle body | | |
| 26 | transport surface | | |
| 27 | base plate | | |
| 28 | energy storage means | | |
| 29 | charging interface | | |
| 30 | end face | | |
| 31 | on/off switch | | |
| 32 | drive unit | A | axis |
| 33 | rotational axis | B | extent in transverse |
| | | | direction, or width |
| 34 | rotational axis | D | diameter or diagonal |
| 35 | front portion | E | plane |
| 36 | rear portion | F | main direction of travel |
| 37 | rear edge | H | extent in vertical |
| | | | direction, or height |
| 38 | electric motor | L | vehicle longitudinal axis |
| 39 | electric motor | S | spacing |
| 40 | housing strut | Q | vehicle transverse axis |
| 41 | double converter | X | longitudinal direction |
| 42 | control unit | Y | transverse direction |
| 43 | outer edge | Z | vertical direction |

1. A self-driving vehicle for transporting a receiving container for a fibre sliver over an underlying surface between sliver-delivering and sliver-fed textile machines, the vehicle comprising:
an undercarriage including a plurality of wheels, wherein two of the plurality of wheels are fixed wheels, with each fixed wheel being aligned in a longitudinal direction of the vehicle and having a rational axis;
a vehicle body supported by the undercarriage and including a transport surface for the receiving container;
fastening elements for fastening the receiving container to the vehicle body; and
an on-board electrical system arranged on the vehicle boy and including an electrical energy storage means, an electrical drive unit and a control unit;
wherein the two fixed wheels have rotational axes that are fixed with respect to the vehicle body; and
wherein the plurality of wheels further comprises at least one spring-mounted support wheel supported on the vehicle body via a spring arrangement and configured to be freely pivotable about a pivot axis.

2. The self-driving vehicle according to claim 1, wherein a notional straight line connects the rotational axes of the fixed wheels to one another and divides the vehicle body in the longitudinal direction of the vehicle into a front portion and a rear portion.

3. The self-driving vehicle according to claim 2, wherein the vehicle has a yaw axis that perpendicular intersects the notional straight line.

4. The self-driving vehicle according to claim 2, wherein the at least one spring-mounted support wheel is supported against the rear portion of the vehicle body.

5. The self-driving vehicle according to claim 2, wherein the plurality of wheels comprise at least one further support wheel configured to be freely pivotable about a further pivot axis, the at least one further support wheel being supported against the front portion of the vehicle body.

6. The self-driving vehicle according to claim 5, wherein the at least one further support wheel is supported against the front portion without being spring mounted.

7. The self-driving vehicle according to claim 5, wherein the at least one further support wheel is mounted against the front portion via a further spring arrangement.

8. The self-driving vehicle according to claim 5, wherein the at least one spring-mounted support wheel and the at least one further support wheel are spaced apart from one another in a transverse direction of the vehicle, and further including a wheel-free function portion extending between the at least one spring-mounted support wheel and the at least one further support wheel, in the longitudinal direction of the vehicle.

9. The self-driving vehicle according to claim 8, further comprising a reading unit on the wheel-free function portion of the vehicle body for detecting guide elements arranged on the underlying surface.

10. The self-driving vehicle according to claim 1, wherein the drive unit is in driving connection with the two fixed wheels and includes an electric motor, for each fixed wheel.

11. The self-driving vehicle according to claim 1, wherein the vehicle is dimensioned so that in an installed state, in which the receiving container is in contact with the transport surface and is fastened to the vehicle body, the receiving container entirely covers the undercarriage, the electrical drive unit and the electrical energy storage means.

12. The self-driving vehicle according to claim 1, wherein the transport surface defines a support plane, and the vehicle has no components projecting beyond the support plane outside the transport surface.

13. A can device having a receiving container for a fibre sliver and a self-driving vehicle for transporting the receiving container over an underlying surface between sliver-delivering and sliver-fed textile machines, wherein the self-driving vehicle is configured according to claim 1 and the receiving container is in contact with the transport surface of the vehicle and fastened to the vehicle body.

14. The can device according to claim 13, wherein the receiving container includes a recessed supporting structure in contact with the transport surface, wherein the supporting structure divides an interior space of the receiving container into a filling space, which is open towards a top of the container for receiving the fibre sliver and an equipment space, which is open towards the bottom of the container in which the vehicle is installed.

15. The can device according to claim 13, wherein the receiving container entirely covers the undercarriage, the electrical drive unit and the electrical energy storage means.

16. The self-driving vehicle according to claim 1, wherein the electric motor for each fixed wheel comprises a wheel hub motor.
